(19) United States
(12) Patent Application Publication
(10) Pub. No.: US 2017/0048916 A1
(43) Pub. Date: Feb. 16, 2017

(54) OPERATION METHOD OF A COMMUNICATION NODE IN A NETWORK SUPPORTING LICENSED BAND AND UNLICENSED BAND

(71) Applicant: Electronics and Telecommunications Research Institute, Daejeon (KR)

(72) Inventors: Sung Jin YOO, Daejeon (KR); Jung Sun UM, Daejeon (KR); Hoi Yoon JUNG, Daejeon (KR); Seung Keun PARK, Daejeon (KR)

(21) Appl. No.: 15/234,047

(22) Filed: Aug. 11, 2016

(30) Foreign Application Priority Data
Aug. 13, 2015 (KR) 10-2015-0114669
Aug. 5, 2016 (KR) 10-2016-0099963

(51) Int. Cl. H04W 76/04; H04W 72/04; H04L 12/26; H04B 17/318; H04W 24/10

(52) U.S. Cl. CPC H04W 76/046; H04B 17/318; H04W 24/10; H04L 43/16; H04W 72/0413; H04W 88/02

(57) ABSTRACT

An operation method of a communication node supporting a licensed band and an unlicensed band is disclosed. As an exemplary embodiment according to the present disclosure, an operation method of a user equipment (UE) in a communication network may comprise measuring a received signal strength during a measurement period in an unlicensed band; determining a channel occupation status by comparing the measured received signal strength with a predetermined threshold; and reporting information indicating the channel occupation status to a base station. Therefore, performance of the communication network can be enhanced.

### CROSS-REFERENCE TO RELATED APPLICATIONS

This application claims the benefit of and priority to Korean Patent Application No. 10-2015-0114669 filed on Aug. 13, 2015 and No. 10-2016-0099963 filed on Aug. 5, 2016 in the Korean Intellectual Property Office (KIPO), the entire contents of which are hereby incorporated by reference.

### BACKGROUND

1. Technical Field

The present disclosure relates to a communication technology for a licensed band and an unlicensed band, and more specifically, to a channel access technology based on a channel occupation status in an unlicensed band.

2. Related Art

Various wireless communication technologies are being developed in accordance with advancement of information communication technologies. Wireless communication technologies may be generally classified into technologies using licensed bands and technologies using unlicensed bands (e.g. industrial-scientific-medical (ISM) band) according to bands used by respective technologies. Since a licensed band is exclusively used by a specific operator, the technology using the licensed band may provide better reliability, communication quality, etc. than that using an unlicensed band.

There exists, as a representative cellular communication technology using a licensed band, a Long Term Evolution (LTE) or LTE-Advanced standardized in a 3^{rd} generation partnership project (3GPP). Thus, a base station or a user equipment (UE) supporting LTE or LTE-Advanced may transmit or receive signals through a licensed band. Also, there exists, as a representative wireless communication technology using an unlicensed band, a wireless local area network (WLAN) defined in IEEE 802.11. Thus, an access point or a station supporting the WLAN may transmit or receive signals through the unlicensed band.

Meanwhile, as mobile traffics are increasing explosively, additional licensed bands are required in order to process such the increasing mobile traffics through licensed bands. However, licensed bands are limited resources. Since a licensed band is obtained usually through an auction held among operators, astronomical investment may be demanded for obtaining an additional licensed band. In order to resolve the above-described problem, a method for providing LTE or LTE-Advanced service through an unlicensed band may be considered.

In the case that the LTE or LTE-Advanced service is provided through the unlicensed band, coexistence with communication nodes (e.g. access point (AP), non-AP station, etc.) supporting WLAN may be required. For the coexistence in the unlicensed band, the communication node (e.g. base station or UE) supporting the LTE or LTE-Advanced service may occupy the unlicensed band according to a listen-before-talk (LBT) operation. For example, the communication node supporting LTE or LTE-Advanced service may determine a content window (CW) by performing a random backoff operation, select a backoff value randomly within the determined CW, and occupy the unlicensed band when a status of the unlicensed band is maintained as idle state during a time duration corresponding to the backoff value.

Here, the size of CW may be changed statically or dynamically. However, a procedure for changing the size of CW in the unlicensed band through which the LTE or LTE-Advanced service is provided has not been defined. Also, there is a problem that the size of CW changes without consideration on the status of the unlicensed band.

Meanwhile, this description on the related arts is written for understanding of the background of the present disclosure. Thus, information on other than conventional technologies, which are already known to those skilled in this technology domain to which the technologies of the present disclosure belong, may be included in this description.

### SUMMARY

Accordingly, exemplary embodiments of the present disclosure provide methods for measuring a channel occupation status in an unlicensed band.

In accordance with the embodiments of the present disclosure, an operation method of a user equipment (UE) in a communication network may be provided. The method may comprise measuring a received signal strength during a measurement period in an unlicensed band; determining a channel occupation status by comparing the measured received signal strength with a predetermined threshold; and reporting information indicating the channel occupation status to a base station.

Here, the channel occupation status may be determined as a ratio of a period of time during which the received signal strength is not less than the predetermined threshold to the measurement period.

Here, the channel occupation status may be determined as a ratio of the number of samples of the received signal strength which is not less than the predetermined threshold to the number of total samples of the received signal strength in the measurement period.

Here, the information indicating the channel occupation status may be reported to the base station through a physical uplink control channel (PUCCH) or a physical uplink shared channel (PUSCH).

Here, the method may further comprise receiving a message requesting to measure the channel occupation status from the base station. Also, the message may include information on periodicity of the measurement period and a start time of the measurement of the received signal strength. Also, the message may further include information on a channel frequency to be measured, the predetermined threshold, and a length of the measurement period. Also, the message may be a radio resource control (RRC) message.

Furthermore, in accordance with the embodiments of the present disclosure, an operation method of a base station in a communication network may be provided. The method may comprise generating a first message requesting measurement of a channel occupation status; transmitting the first message to a user equipment (UE); and in response to the first message, receiving, from the UE, a second message including information indicating the channel occupation status determined based on a result of comparison between a predetermined threshold and a received signal strength measured during a measurement period in an unlicensed band.

Here, the channel occupation status may be determined as a ratio of a period of time during which the received signal strength is not less than the predetermined threshold to the measurement period.

Here, the channel occupation status may be determined as a ratio of the number of samples of the received signal strength which is not less than the predetermined threshold to the number of total samples of the received signal strength in the measurement period.

Here, the first message may include information on periodicity of the measurement period and a start time of the measurement of the received signal strength. Also, the first message may further include information on a channel frequency to be measured, the predetermined threshold, and a length of the measurement period.

Here, the first message may be a radio resource control (RRC) message.

Here, the second message may be received from the UE through a physical uplink control channel (PUCCH) or a physical uplink shared channel (PUSCH).

Furthermore, in accordance with the embodiments of the present disclosure, a user equipment (UE) supporting an unlicensed band may include a processor and a memory in which at least one instruction executed by the processor is stored. Also, the at least one instruction may be executed to measure a received signal strength during a measurement period in an unlicensed band; determine a channel occupation status by comparing the measured received signal strength with a predetermined threshold; and report information indicating the channel occupation status to a base station.

Here, the channel occupation status may be determined as a ratio of a period of time during which the received signal strength is not less than the predetermined threshold to the measurement period.

Here, the channel occupation status may be determined as a ratio of the number of samples of the received signal strength which is not less than the predetermined threshold to the number of total samples of the received signal strength in the measurement period.

Here, the at least one instruction may further be executed to receive a message requesting measurement of the channel occupation status from the base station. Also, the message may further include information on a channel frequency to be measured, the predetermined threshold, and a length of the measurement period.

Using exemplary embodiments according to the present disclosure, a communication node supporting a LBT operation may measure a channel occupation status (e.g. degree of channel congestion) in an unlicensed band. The channel occupations status may be measured based on the number of communication nodes operating in the corresponding channel, received signal strength (e.g. RSSI) measured in the corresponding channel, etc. The measured channel occupation status can be represented in a simple form, and information indicating the measured channel occupation status can be shared among communication nodes (e.g. base station-UE or base station-base station). For example, the measured channel occupation status can be represented with relatively fewer bits (e.g. 3 bits, 4 bits, etc.) whereby overhead in a procedure for exchanging the information indicating the channel occupation status can be reduced.

Also, the communication node supporting a LBT operation may determine the size of contention window (CW) based on the channel occupation status, and perform communications based on the determined size of CW. Also, the communication node supporting a LBT operation may select a channel from a plurality of channels based on channel occupation statuses of the plurality of channels, and perform communications in the selected channel. Also, a hidden node problem can be resolved by using the channel occupation status.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a first exemplary embodiment of a wireless communication network;

FIG. 2 is a conceptual diagram illustrating a second exemplary embodiment of a wireless communication network;

FIG. 3 is a conceptual diagram illustrating a third exemplary embodiment of a wireless communication network;

FIG. 4 is a conceptual diagram illustrating a fourth exemplary embodiment of a wireless communication network;

FIG. 5 is a block diagram illustrating an embodiment of a communication node constituting a wireless communication network;

FIG. 6 is a sequence chart illustrating a channel access method based on a channel occupation status;

FIG. 7 is a timing diagram illustrating a first exemplary embodiment for determining a channel occupation status of an unlicensed band according to the present disclosure;

FIG. 8 is a timing diagram illustrating a second exemplary embodiment for determining a channel occupation status of an unlicensed band according to the present disclosure;

FIG. 9 is a timing diagram illustrating an example of sampling during a measurement period;

FIG. 10 is a timing diagram illustrating a third exemplary embodiment for determining a channel occupation status of an unlicensed band according to the present disclosure;

FIG. 11 is a flow chart illustrating a method for changing the size of CW based on a change amount of channel occupation status;

FIG. 12 is a sequence chart illustrating an exemplary embodiment of a method for changing the size of contention window based on channel occupation status; and

FIG. 13 is a sequence chart illustrating an exemplary embodiment of a method for activating an unlicensed band channel based on channel occupation status.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

Hereinafter, wireless communication networks to which exemplary embodiments according to the present disclosure will be described. However, wireless communication networks to which exemplary embodiments according to the present disclosure are applied are not restricted to what will be described below. That is, exemplary embodiments according to the present disclosure may be applied to various wireless communication networks.

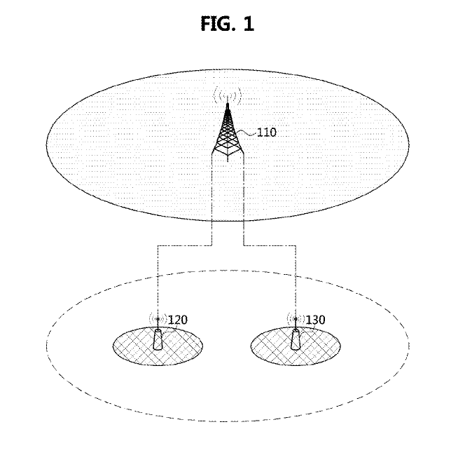

FIG. 1 is a conceptual diagram illustrating a first exemplary embodiment of a wireless communication network.

Referring to FIG. 1, a first base station 110 may support cellular communications (e.g. Long Term Evolution (LTE), LTE-Advanced (LTE-A), Licensed Assisted Access (LAA), etc. standardized in a 3^{rd} Generation Partnership Project (3GPP). The first base station 110 may support technologies such as a Multiple Input Multiple Output (MIMO) (e.g. Single-User (SU)—MIMO, Multi-User (MU)—MIMO, massive MIMO, etc.), a Coordinated multi-point transmission/reception (CoMP), a Carrier Aggregation (CA), etc. The first base station 110 may operate in a licensed band F1, and form a macro cell. The first base station 100 may be connected to other base stations (e.g. a second base station 120, a third base station 130, etc.) through ideal backhaul links or non-ideal backhaul links.

The second base station 120 may be located in coverage of the first base station 110. Also, the second base station 120 may operate in an unlicensed band F3, and form a small cell. The third base station 130 may also be located in coverage of the first base station 110. The third base station 130 may operate in the unlicensed band F3, and form a small cell. The second base station 120 and the third base station 130 each may support a Wireless Local Area Network (WLAN) standardized in an Institute of Electrical and Electronics Engineers (IEEE) 802.11. Each user equipment (UE) connected to the first base station 110 may transmit and receive signals through a CA using the licensed band F1 and the unlicensed band F3.

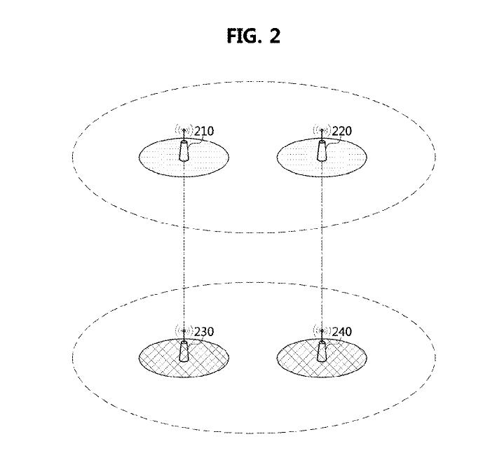

FIG. 2 is a conceptual diagram illustrating a second exemplary embodiment of a wireless communication network.

Referring to FIG. 2, each of a first base station 210 and a second base station 220 may support cellular communications (e.g. LTE, LTE-A, LAA, etc.). Each of the first base station 210 and the second base station 220 may support MIMO (e.g. SU-MIMO, MU-MIMO, massive MIMO, etc.), CoMP, CA, etc. Also, each of the base stations 210 and 220 may operate in the licensed band F1, and form each small cell. Each of the base stations 210 and 220 may be located in coverage of a base station forming a macro cell. The first base station 210 may be connected with a third base station 230 through an ideal backhaul link or a non-ideal backhaul link. Also, the second base station 220 may be connected with a fourth base station 240 through an ideal backhaul link or a non-ideal backhaul link.

The third base station 230 may be located in coverage of the first base station 210. The third base station 230 may operate in the unlicensed band F3, and form a small cell. The fourth base station 240 may be located in coverage of the second base station 220. The fourth base station 240 may operate in the unlicensed band F3, and form a small cell. Each of the base stations 230 and 240 may support WLAN standardized in IEEE 802.11. Each of the first base station 210, an UE connected to the first base station 210, the second base station 220, and an UE connected to the second base station 220 may transmit and receive signals through a CA using the licensed band F1 and the unlicensed band F3.

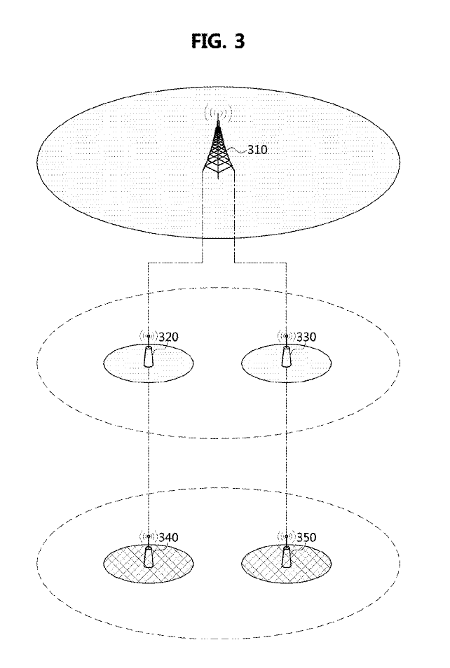

FIG. 3 is a conceptual diagram illustrating a third exemplary embodiment of a wireless communication network.

Referring to FIG. 3, each of a first base station 310, a second base station 320, and a third base station 330 may support cellular communications (e.g. LTE, LTE-A, LAA, etc.). Each of the first base station 310, the second base station 320, and the third base station 330 may support MIMO (e.g. SU-MIMO, MU-MIMO, massive MIMO, etc.), CoMP, CA, etc. The first base station 310 may operate in the licensed band F1, and form a macro cell. The first base station 310 may be connected to other base stations (e.g. the second base station 320, the third base station 330, etc.) through ideal backhaul links or non-ideal backhaul links. The second base station 320 may be located in coverage of the first base station 310. The second base station 320 may operate in the licensed band F1, and form a small cell. The third base station 330 may be located in coverage of the first base station 310. The third base station 330 may operate in the licensed band F1, and form a small cell.

The second base station 320 may be connected with a fourth base station 340 through an ideal backhaul link or a non-ideal backhaul link. The fourth base station 340 may be located in coverage of the second base station 320. The fourth base station 340 may operate in the unlicensed band F3, and form a small cell. The third base station 330 may be connected with a fifth base station 350 through an ideal backhaul link or a non-ideal backhaul link. The fifth base station 350 may be located in coverage of the third base station 330. The fifth base station 350 may operate in the unlicensed band F3, and form a small cell. Each of the base stations 340 and 350 may support WLAN standardized in IEEE 802.11.

Each of the first base station 310, an UE (not-depicted) connected to the first base station 310, the second base station 320, an UE (not-depicted) connected to the second base station 320, the third base station 330, and an UE (not-depicted) connected to the third base station 330 may transmit and receive signals through a CA using the licensed band F1 and the unlicensed band F3.

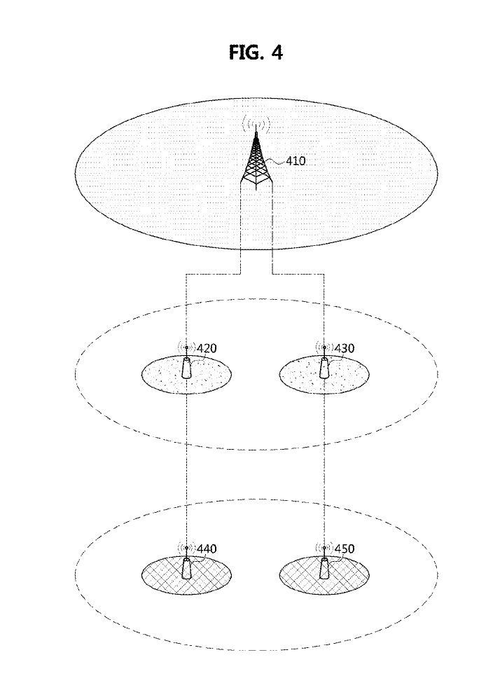

FIG. 4 is a conceptual diagram illustrating a fourth exemplary embodiment of a wireless communication network.

Referring to FIG. 4, each of a first base station 410, a second base station 420, and a third base station 430 may support cellular communications (e.g. LTE, LTE-A, LAA, etc.). Each of the first base station 410, the second base station 420, and the third base station 430 may support MIMO (e.g. SU-MIMO, MU-MIMO, massive MIMO, etc.), CoMP, CA, etc. The first base station 410 may operate in the licensed band F1, and form a macro cell. The first base station 410 may be connected to other base stations (e.g. the second base station 420, the third base station 430, etc.) through ideal backhaul links or non-ideal backhaul links. The second base station 420 may be located in coverage of the first base station 410. The second base station 420 may operate in the licensed band F2, and form a small cell. The third base station 430 may be located in coverage of the first base station 410. The third base station 430 may operate in the licensed band F2, and form a small cell. Each of the second base station 420 and the third base station 430 may operate in the licensed band F2 different from the licensed band F1 in which the first base station 410 operates.

The second base station 420 may be connected with a fourth base station 440 through an ideal backhaul link or a non-ideal backhaul link. The fourth base station 440 may be located in coverage of the second base station 420. The fourth base station 440 may operate in the unlicensed band F3, and form a small call. The third base station 430 may be connected with a fifth base station 450 through an ideal backhaul link or a non-ideal backhaul link. The fifth base station 450 may be located in coverage of the third base station 430. The fifth base station 450 may operate in the unlicensed band F3, and form a small cell. Each of the base stations 440 and 450 may support WLAN standardized in IEEE 802.11.

Each of the first base station 410 and an UE (not-depicted) connected to the first base station 410 may transmit and receive signals through a CA using the licensed band F1 and the unlicensed band F3. Each of the second base station 420, an UE (not-depicted) connected to the second base station 420, the third base station 430, and an UE (not-depicted) connected to the third base station 430 may transmit and receive signals through a CA using the licensed band F2 and the unlicensed band F3.

The above-described communication nodes constituting a wireless communication network (e.g. a base station, an UE, etc.) may transmit signals according to a Listen-Before-Talk (LBT) procedure in the unlicensed band. That is, the communication node may determine whether the unlicensed band is occupied or not by performing an energy detection operation. The communication node may transmit a signal when the unlicensed band is determined as idle state. In this case, the communication node may transmit a signal when the unlicensed band is maintained as idle state during a contention window according to a random backoff operation. On the contrary, when the unlicensed band is determined as a busy state, the communication node may not transmit a signal.

Alternatively, the communication entity may transmit a signal based on a Carrier Sensing Adaptive Transmission (CSAT) operation. That is, the communication node may transmit a signal based on a pre-configured duty cycle. The communication node may transmit a signal when a current duty cycle is a duty cycle assigned for communication nodes supporting cellular communications. On the contrary, the communication node may not transmit a signal when a current duty cycle is a duty cycle assigned for communication nodes supporting other communications (e.g. WLAN, etc.) except cellular communications. The duty cycle may be determined adaptively based on the number of communication nodes existing and supporting WLAN in the unlicensed band, a usage state of the unlicensed band, etc.

The communication node may perform discontinuous transmission in the unlicensed band. For example, if a maximum transmission duration or a maximum channel occupancy time is configured for the unlicensed band, the communication node may transmit signals during the maximum transmission duration or the maxim channel occupancy time. In a case that the communication node cannot transmit whole signals during the current maximum transmission duration (or, maximum channel occupancy time), the communication node may transmit the rest of signals in a next maximum transmission duration. Also, the communication node may select a carrier having relatively smaller interferences among unlicensed bands, and operate in the selected carrier. Also, in the case that the communication node transmits signals in the unlicensed band, transmission power can be controlled in order to reduce interferences to other communication nodes.

On the other hand, the communication node may support communication protocols based on code division multiple access (CDMA), wideband CDMA (WCDMA), time division multiple access (TDMA), frequency division multiple access (FDMA), single carrier FDMA (SC-FDMA), orthogonal frequency division multiplexing (OFDM), or orthogonal frequency division multiple access (OFDMA).

A base station among communication nodes may be referred to as a Node-B (NB), an evolved Node-B (eNB), a base transceiver station (BTS), a radio base station, a radio transceiver, an access point (AP), or an access node. Also, a user equipment (UE) among communication nodes may be referred to as a terminal, an access terminal, a mobile terminal, a station, a subscriber station, a portable subscriber station, a mobile station, a node, or a device. The communication node may have a structure which will be described below.

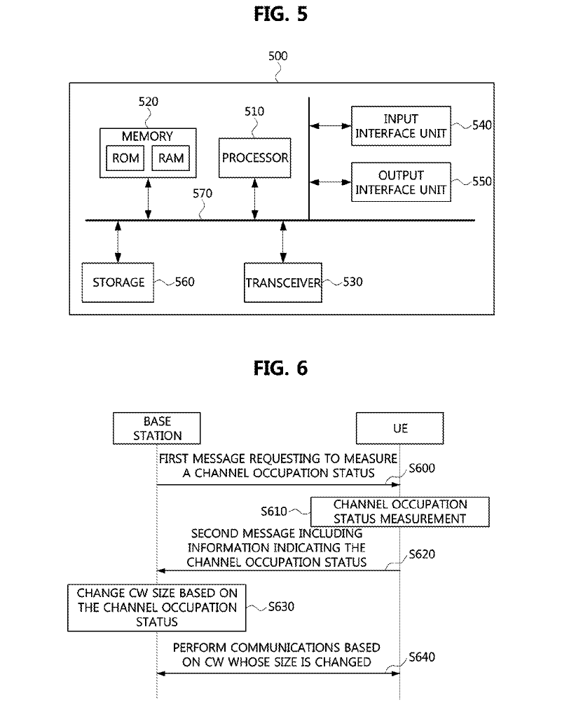

FIG. 5 is a block diagram illustrating an embodiment of a communication node constituting a wireless communication network.

Referring to FIG. 5, a communication node 500 may include at least one processor 510, a memory 520 and a transceiver 530 connected to a network and performing communication. Further, the communication node 500 may include an input interface unit 540, an output interface unit 550, and a storage 560. The respective components included in the communication node 500 may be connected via a bus 570 to communicate with each other.

The processor 510 may perform a program command stored in the memory 520 and/or the storage 560. The processor 510 may be a central processing unit (CPU), a graphics processing unit (GPU) or a dedicated processor in which the methods according to embodiments of the present disclosure are performed. The memory 520 and the storage 560 may include a volatile storage medium and/or a nonvolatile storage medium. For example, the memory 520 may include a read only memory (ROM) and/or a random access memory (RAM).

Operation methods of the communication node in the wireless communication network will be described below. Although a method (e.g., signal transmission or reception) performed by a first communication node will be described, a second communication node corresponding thereto may perform a method (e.g., signal reception or transmission) corresponding to the method performed by the first communication node. That is, when an operation of the UE is described, the base station corresponding thereto may perform an operation corresponding to the operation of the UE. On the contrary, when an operation of the base station is described, the UE may perform an operation corresponding to an operation of the base station.

Meanwhile, a carrier aggregation may be applied to at least one of unlicensed band cells and at least one of licensed band cells. Configuration, addition, modification, or release of the unlicensed band cell may be performed through a radio resource control (RRC) signaling (e.g. transmission and reception of ‘RRCConnectionReconfiguration’ messages (hereinafter, referred to as a ‘RRC message’)). The RRC message may be transmitted to a UE through the licensed band cell, and may include information required for management and operation of the unlicensed band cell.

An initial state of an unlicensed band secondary cell which is configured or added may be a deactivation state. After the state of the unlicensed band secondary cell is transitioned from the deactivation state to an activation state, communications can be performed in the unlicensed band secondary cell.

Unlike the licensed bands, a period during which signals can be transmitted continuously in an unlicensed band may be restricted within the maximum transmission duration (or, maximum occupation duration). Also, in the case that signals are transmitted based on channel occupation status (e.g. the case that signals are transmitted based on LBT), signals are transmitted when transmissions of other communication nodes have completed. When LTE (or, LTE-A) services are provided through the unlicensed band, transmission of a communication node supporting LTE or LTE-A services may have non-periodical, non-continuous, and opportunistic characteristics. According to such the characteristics, signals which are continuously transmitted by the communication node supporting LTE or LTE-A services during a predetermined time in an unlicensed band may be referred to as ‘unlicensed band burst’.

Also, a set of continuous subframes comprising a combination of one or more channels (e.g. PCFICH, PHICH, PDCCH, EPDCCH, PDSCH, physical multicast channel (PMCH), PUCCH, PUSCH, etc.) and signals (e.g. synchronization signals, reference signals, etc.) defined in the licensed band may be transmitted through the unlicensed band. In this case, the transmission of subframes may be referred to as ‘unlicensed band transmission’.

Frames used for transmission in the unlicensed band may be classified into downlink unlicensed band burst frames, uplink unlicensed band burst frames, and downlink/uplink unlicensed band burst frames. The downlink unlicensed band burst frame may include subframes to which the unlicensed band transmission is applied, and further include unlicensed band signals. In the downlink unlicensed band burst frame, the unlicensed band signal may be located before the subframe to which the unlicensed band transmission is applied. The unlicensed band signal may be configured so that timing of the subframe (or, slot timing or OFDM symbol timing) to which the unlicensed band transmission is applied coincides with timing of a subframe (or, slot timing or OFDM symbol timing) in the licensed band. Also, the unlicensed band signal may be used for automatic gain control (AGC), synchronization acquisition, channel estimation, etc. required for receiving data transmitted based on the unlicensed band transmission.

The subframe to which the unlicensed band transmission is applied may be configured within the maximum transmission duration (or, maximum occupation duration). That is, the number of subframes to which the unlicensed band transmission is applied may be configured according to the maximum transmission duration (or, maximum occupation duration). Here, the number of subframes to which the unlicensed band transmission is applied may be configured in consideration of the unlicensed band signal. Information on the maximum transmission duration (or, maximum occupation duration) may be informed via RRC signaling. The UE may identify a start point of the unlicensed band burst by detecting the PDCCH (or, EPDCCH) or the unlicensed band signal. The actual occupation time of the unlicensed band burst or the subframe to which the unlicensed band transmission is applied may be identified by using the unlicensed band signal or the PHICH.

The unlicensed band signal may include information (or, a sequence) indicating the number (or, time duration) of subframes used for the unlicensed band burst and the unlicensed band transmission. Alternatively, the information (or, sequence) indicating the number (or, time duration) of subframes used for the unlicensed band burst and the unlicensed band transmission may be transmitted through PHICH.

Transmission of HARQ-related information for uplink in an unlicensed band may be performed asynchronously differently from that of a licensed band. Accordingly, the HARQ-related information, such as HARQ process number and RV, may be transmitted through PDCCH (or, EPDCCH) instead of PHICH. In this case, PHICH may be used for transmitting other information. For example, the information (or, sequence) indicating the number (or, time duration) of subframes used for the unlicensed band burst and the unlicensed band transmission may be transmitted through PHICH.

On the other hand, in a case that an unlicensed band channel is exclusively used by a single wireless communication network, measurement on a channel occupation status (e.g. degree of channel congestion) may be performed with relative easiness. On the contrary, in a case that an unlicensed band channel is shared by a plurality of wireless communication networks, measurement on a channel occupation status may be difficult. For example, in the WLAN standardized by IEEE 802.11, a communication node may determine a channel occupation status as busy when the communication node does not receive an acknowledgement (ACK) frame for a transmitted data frame. In this case, the communication node may increase the size of CW. However, if the above-described determination method is used, the channel occupation status cannot be measured with preciseness.

Hereinafter, exemplary embodiments of a channel occupation status measurement method based on received signal strength indication (RSSI), a channel access method based on the measured channel occupation status, etc. will be described.

FIG. 6 is a sequence chart illustrating a channel access method based on a channel occupation status.

Referring to FIG. 6, a base station and a UE may constitute one of the wireless communication networks explained referring to FIGS. 1 to 4, and support at least one licensed band and unlicensed band. Also, the base station may support a carrier aggregation (CA). Also, each of the base station and the UE may have a structure identical or similar to the structure of the communication node 500 explained referring to FIG. 5. Also, a timing of a subframe (or, slot or OFDM symbol, etc.) of the licensed band may be identical to a timing of a subframe (or, slot or OFDM symbol, etc.) of the unlicensed band.

The base station may transmit to the UE a first message requesting the UE to measure a channel occupation status (S600). Here, the first message may be transmitted to the UE via a higher layer protocol (e.g. radio resource control (RRC) signaling). Alternatively or additionally, the first message may be transmitted to the UE through PDCCH, EPDCCH, or PDSCH of the licensed band or the unlicensed band. The first message may request measurement of a channel occupation status for an unlicensed band cell which is activated or inactivated.

The first message may include at least one of information on a measurement period, information on a channel frequency to be measured (i.e. frequency information for measurement), a predetermined threshold (i.e. a threshold for a received signal strength), information on periodicity of the measurement period, information on a start time of the measurement, information on the length of the measurement period, sampling-related information (e.g. sampling gap, the number of samples (i.e. the number of samples in each measurement period), etc.), and so on. Here, the information on the start time of the measurement may be an offset indicating a time point at which the measurement on the channel occupation status is started.

Then, the UE may receive the first message from the base station. Upon receiving the first message, the UE may measure a channel occupation status based on the information included in the first message (S610). The UE may measure the channel occupation station in a continuous manner or a non-continuous manner (i.e. discrete manner). A method for measuring the channel occupation status based on the continuous manner will be explained as follows.

Method for Measuring Channel Occupation Status Based on a Continuous Manner

The UE may identify a measurement period based on the information included in the first message. That is, if the information on the measurement period is included in the first message, the UE may identify the measurement period for determining a channel occupation status. If the first message includes the information on periodicity of the measurement period and the information on the start time of the measurement (i.e. a case the first message does not include the information on the measurement period), the UE may identify the measurement period of the channel occupation status according to the information on periodicity of the measurement period and the information on the start time of the measurement. Also, the UE may determine that the measurement on the channel occupation status is performed in a channel indicated by the information on the channel frequency to be measured.

The UE may measure a received signal strength (e.g. RSSI) during the measurement period in the unlicensed band. If the unlicensed band cell is in the activation state, signals transmitted from the base station may be excluded from targets of the measurement. The UE may compare the measured received signal strength with the predetermined threshold. The UE may determine that the unlicensed band is busy (i.e. ‘occupied’) in a period of time during which the measured received signal strength is not less than the predetermined threshold. On the contrary, the UE may determine that the unlicensed band is idle (i.e. ‘not-occupied’) in a period of time during which the measured received signal strength is less than the predetermined threshold. The UE may determine the channel occupation status according to the state of the unlicensed band as follows.

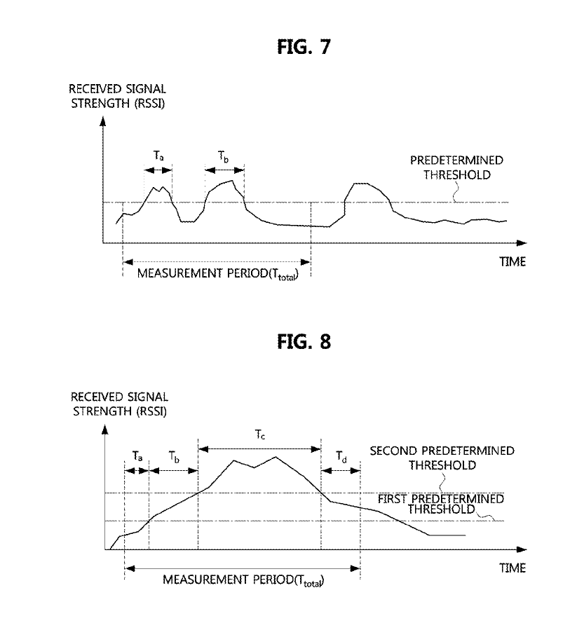

FIG. 7 is a timing diagram illustrating a first exemplary embodiment for determining a channel occupation status of an unlicensed band according to the present disclosure.

Referring to FIG. 7, the UE may determine that the unlicensed band is busy in periods Tₐ and T_{b} of the measurement period Tₜₒₜₐₗ, and determine that the unlicensed band is idle in periods other than the periods Tₐ and T_{b} of the measurement period Tₜₒₜₐₗ. In this case, the UE may determine the channel occupation status based on the below equation 1. That is, the channel occupation status may be determined as a ratio of a period of time during which the received signal strength is not less than the predetermined threshold to the measurement period.

Channel occupation status=(Tₐ+T_{b})/Tₜₒₜₐₗ [Equation 1]

Meanwhile, the UE may determine a channel occupation status by using a plurality of predetermined thresholds as follows.

FIG. 8 is a timing diagram illustrating a second exemplary embodiment for determining a channel occupation status of an unlicensed band according to the present disclosure.

Referring to FIG. 8, in a case that a first predetermined threshold is used, the UE may determine that the unlicensed band is busy in periods T_{b}, T_{c}, and T_{d} of the measurement period Tₜₒₜₐₗ, and determine that the unlicensed band is idle in a period Tₐ of the measurement period Tₜₒₜₐₗ. In this case, the UE may determine the channel occupation status based on the below equation 2.

Channel occupation status=(T_{b}+T_{c}+T_{d})/Tₜₒₜₐₗ [Equation 2]

In a case that a second predetermined threshold is used, the UE may determine that the unlicensed band is busy only in a period T_{c} of the measurement period Tₜₒₜₐₗ, and determine that the unlicensed band is idle in periods Tₐ, T_{b}, and T_{d} of the measurement period Tₜₒₜₐₗ. In this case, the UE may determine the channel occupation status based on the below equation 3.

Channel occupation status=T_{c}/Tₜₒₜₐₗ [Equation 3]

Referring again to FIG. 6, a method for measuring the channel occupation status based on the non-continuous manner (discrete manner) will be explained as follows.

Method for measuring channel occupation status based on a non-continuous manner

The UE may identify a measurement period based on the information included in the first message. That is, in the case that the information on the measurement period is included in the first message, the UE may identify the measurement period for determining a channel occupation status. In the case that the information on periodicity of the measurement period and the information on the start time of the measurement are included in the first message (i.e. a case the first message does not include the information on the measurement period), the UE may identify the measurement period of the channel occupation status according to the information on periodicity of the measurement period and the information on the start time of the measurement. Also, the UE may determine that the measurement on the channel occupation station is performed in a channel indicated by the frequency information for measurement. Also, the UE may identify the number of samples (or, sampling gap) in the measurement period based on the sampling-related information included in the first message. Sampling of received signal strength may be performed as follows.

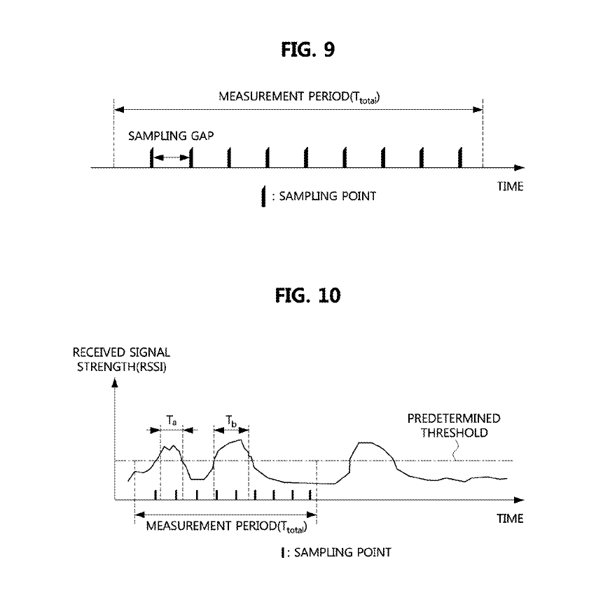

FIG. 9 is a timing diagram illustrating an example of sampling during a measurement period.

Referring to FIG. 9, nine sampling points may exist in a measurement period. Thus, the UE may measure received signal strength at the nine sampling points in the measurement period. Meanwhile, the sampling-related information included in the first message may indicate the number of samples or the sampling gap. In the case that the sampling-related information indicates the number of samples, the UE may identify the sampling gap based on the below equation 4. Also, in the case that the sampling-rated information indicates the sampling gap, the UE may also identify the number of samples in the measurement period based on the below equation 4. In the equation 4, Tₜₒₜₐₗ may mean the length of the measurement period, and Nₜₒₜₐₗ may mean the number of total samples in the measurement period.

Sampling gap=Tₜₒₜₐₗ/Nₜₒₜₐₗ [Equation 4]

Referring again to FIG. 6, the UE may measure a received signal strength (e.g. RSSI) at each sampling point during the measurement period of the unlicensed band. If the unlicensed band cell is in the activation state, signals transmitted from the base station may be excluded from targets of the measurement. The UE may compare the measured received signal strength with the predetermined threshold. The UE may determine that the unlicensed band is busy (i.e. ‘occupied’) at a sampling point where the measured received signal strength is not less than the predetermined threshold. On the contrary, the UE may determine that the unlicensed band is idle (i.e. ‘not-occupied’) at a sampling point where the measured received signal strength is less than the predetermined threshold. The UE may determine the channel occupation status according to the state of the unlicensed band as follows.

FIG. 10 is a timing diagram illustrating a third exemplary embodiment for determining a channel occupation status of an unlicensed band according to the present disclosure.

Referring to FIG. 10, the UE may determine that the unlicensed band is busy at sampling points in periods Tₐ and T_{b} of the measurement period Tₜₒₜₐₗ, and determine that the unlicensed band is idle at sampling points in periods other than the periods Tₐ and T_{b} of the measurement period Tₜₒₜₐₗ. In this case, the UE may determine the channel occupation status based on the below equation 5. That is, the channel occupation status may be determined as a ratio of the number of samples of the received signal strength which is not less than the predetermined threshold to the number of total samples of the received signal strength in the measurement period.

Channel occupations status=Nₜₕ/Nₜₒₜₐₗ [Equation 5]

Here, Nₜₒₜₐₗ may indicate the number of total samples in the measurement period (Tₜₒₜₐₗ). For example, Nₜₒₜₐₗ may be 9. Also, Nₜₕ may indicate the number of samples where the unlicensed band is busy. For example, Nₜₕ may be 3.

Referring again to FIG. 6, in response to the first message, the UE may transmit a second message including information indicating a channel occupation status to the base station (S620). The second message may be transmitted through the licensed band or the unlicensed band. The second message may be transmitted to the base station via a higher layer protocol (e.g. radio resource control (RRC) signaling). Alternatively or additionally, the second message may be transmitted to the base station through PUCCH or PUSCH of the licensed band or the unlicensed band.

The information indicating the channel occupation station may be represented as an index. For example, the channel occupation status (e.g. a percentage value (%)) may be quantized uniformly (e.g. linearly) or non-uniformly (e.g. non-linearly), and an index may indicate the quantized channel occupation status. For example, the index may be represented with three bits as illustrated in the below table 1. In the table 1, a channel occupation status index may indicate a percentage value range of the channel occupation status determined based on the equation 1, 2, 3, or 5.

TABLE 1

| Channel | |
|---|---|
| occupation status | |
| index | Channel occupation status (%) |
| 000 | 0 <= channel occupation status <12.5 |
| 001 | 12.5 <= channel occupation status <25 |
| 010 | 25 <= channel occupation status <37.5 |
| 011 | 37.5 <= channel occupation status <50 |
| 100 | 50 <= channel occupation status <62.5 |
| 101 | 62.5 <= channel occupation status <75 |
| 110 | 75 <= channel occupation status <87.5 |
| 111 | 87.5 <= channel occupation status <100 |

Also, the channel occupation status index may be represented with four bits as illustrated in the table 2. In the table 2, the channel occupation status index may indicate a percentage value range of the channel occupation status determined based on the equation 1, 2, 3, or 5.

TABLE 2

| Channel | |
|---|---|
| occupation status | |
| index | Channel occupation status (%) |
| 0000 | 0 <= channel occupation status <6.25 |
| 0001 | 6.25 <= channel occupation status <12.5 |
| 0010 | 12.5 <= channel occupation status <18.75 |
| 0011 | 18.75 <= channel occupation status <25 |
| 0100 | 25 <= channel occupation status <31.25 |
| 0101 | 31.25 <= channel occupation status <37.5 |
| 0110 | 37.5 <= channel occupation status <43.75 |
| 0111 | 43.75 <= channel occupation status <50 |
| 1000 | 50 <= channel occupation status <56.25 |
| 1001 | 56.25 <= channel occupation status <62.5 |
| 1010 | 62.5 <= channel occupation status <68.75 |
| 1011 | 68.75 <= channel occupation status <75 |
| 1100 | 75 <= channel occupation status <81.25 |
| 1101 | 81.25 <= channel occupation status <87.5 |
| 1110 | 87.5 <= channel occupation status <93.75 |
| 1111 | 93.75 <= channel occupation status <100 |

Referring again to FIG. 6, the base station may receive the second message from the UE, and change the size of CW based on the information indicating the channel occupation status included in the second message (S630). For example, when the channel occupation status is not less than the predetermined threshold, the base station may increase the size of CW. On the contrary, when the channel occupation status is less than the predetermined threshold, the base station may maintain, initialize, or reduce the size of CW.

Alternatively, the base station may change the size of CW based on the amount of a change from a previous channel occupation status to a current channel occupation status. A method for changing the size of CW based on the amount of a change from a previous channel occupation status to a current channel occupation status may be explained as follows.

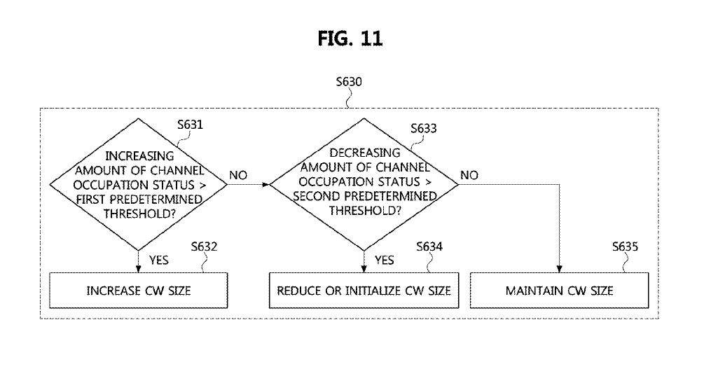

FIG. 11 is a flow chart illustrating a method for changing the size of CW based on a change amount of channel occupation status.

Referring to FIG. 11, the base station may calculate an increasing amount of channel occupation status, from a previous channel occupation status to a current channel occupation status, and compare the calculated amount with a first predetermined threshold (S631). In a case that the calculated amount is larger than the first predetermined threshold, the base station may increase the size of CW (S632).

In a case that the calculated amount is equal to or less than the first predetermined threshold, the base station may calculate a decreasing amount of channel occupation status, from the previous channel occupation status to the current channel occupation status, and compare the calculated amount with a second predetermined threshold (S633). In a case that the calculated amount is larger than the second predetermined threshold, the base station may reduce or initialize the size of CW (S634). In a case that the calculated amount is equal to or less than the second predetermined threshold, the base station may maintain the size of CW (S635).

Referring again to FIG. 6, the base station may perform communications in the unlicensed band according to the CW the size of which is changed (S640). For example, the base station may select a backoff value within the changed CW, and transmit a signal through the unlicensed band, when the unlicensed band is maintained as idle state during a time duration corresponding to the selected backoff value. Meanwhile, the base station may inform the UE of the changed size of CW. For example, information on the changed size of CW may be transmitted as included in a RRC message or a downlink control information (DCI).

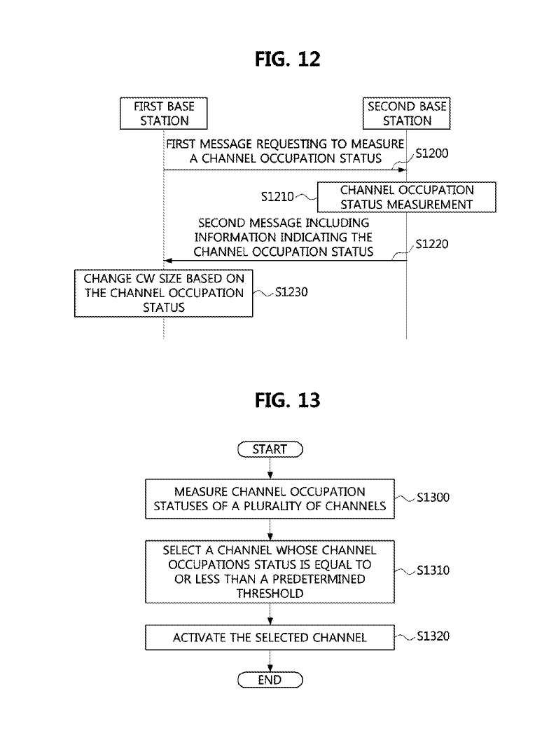

FIG. 12 is a sequence chart illustrating an exemplary embodiment of a method for changing the size of contention window based on channel occupation status.

Referring to FIG. 12, a first base station and a second base station may constitute one of the wireless communication networks explained referring to FIGS. 1 to 4, and support a licensed band and an unlicensed band. The first base station and the second base station may support a carrier aggregation (CA). Also, each of the first base station and the second base station may have a structure identical or similar to the structure of the communication node 500 explained referring to FIG. 5. Also, a timing of a subframe (or, slot or OFDM symbol, etc.) of the licensed band may be identical to a timing of a subframe (or, slot or OFDM symbol, etc.) of the unlicensed band.

The first base station may transmit, to the second base station, a first message requesting the second base station to measure a channel occupation status (S1200). The first message may be transmitted to the second base station via a higher layer protocol or an X2 interface. The first message may be identical to the first message explained referring to FIG. 6.

The second base station may receive the first message from the first base station. Then, the second base station may measure the channel occupation status based on the information included in the first message (S1210). The second base station may measure the channel occupation status in a manner identical or similar to that of the step S610 explained referring to FIG. 6.

In response to the first message, the second base station may transmit a second message including information indicating the measured channel occupation status to the first base station (S1220). The second message may be transmitted to the first base station via a higher layer protocol or an X2 interface. The second message may be identical to the second message explained referring to FIG. 6.

The first base station may receive the second message from the second base station. The first base station may change the size of CW according to the channel occupations status information included in the second message (S1230). The first base station may change the size of CW in a manner identical or similar to that of the step S630 explained referring to FIG. 6.

Also, the first base station may perform communications through the unlicensed band according to the CW whose size has been changed. Here, the first base station may perform communications in manner identical or similar to that of the step S640 explained referring to FIG. 6. Also, the first base station may inform the UE of the changed size of CW. For example, information on the changed size of CW may be transmitted as included in a RRC message or a DCI.

Hereinafter, a method for activating an unlicensed band channel based on channel occupation status will be described. Here, an unlicensed band channel may be an unlicensed band cell.

FIG. 13 is a sequence chart illustrating an exemplary embodiment of a method for activating an unlicensed band channel based on channel occupation status.

Referring to FIG. 13, a communication node (e.g. base station or UE) may constitute one of the wireless communication networks explained referring to FIGS. 1 to 4, and support a licensed band and an unlicensed band. The communication node may support a carrier aggregation (CA). The communication node may have a structure identical or similar to the structure of the communication node 500 explained referring to FIG. 5. Also, a timing of a subframe (or, slot or OFDM symbol, etc.) of the licensed band may be identical to a timing of a subframe (or, slot or OFDM symbol, etc.) of the unlicensed band.

The communication node may measure channel occupation statuses of a plurality of channels in the unlicensed band (S1300). For example, the communication node may measure channel occupation statuses of a plurality of channels in the unlicensed band, based on the channel occupation status measurement methods explained referring to FIG. 6 or 12.

The communication node may compare a channel occupation status of each channel among the plurality of channels with a predetermined threshold. The communication node may select at least one channel having a channel occupation status equal to or less than the predetermined threshold (S1310). The communication node may activate the selected unlicensed band channel (S1320). For example, in a case that the communication node is a base station, the communication node may request an UE to activate the selected unlicensed band channel. Also, when the request is received at the UE, the UE may activate the selected unlicensed band channel. Alternatively, in a case that the communication node is an UE, the UE may directly activate the selected unlicensed band channel. The base station and the UE may perform communications through the activated unlicensed band channel

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a user equipment (UE) in a communication network, the method comprising:
measuring received signal strength during a measurement period in an unlicensed band;
determining a channel occupation status by comparing the measured received signal strength with a predetermined threshold; and
reporting information indicating the channel occupation status to a base station.

2. The method according to claim 1, wherein the channel occupation status is determined as a ratio of a period of time during which the received signal strength is not less than the predetermined threshold to the measurement period.

3. The method according to claim 1, wherein the channel occupation status is determined as a ratio of a number of samples of the received signal strength which is not less than the predetermined threshold to a number of total samples of the received signal strength in the measurement period.

4. The method according to claim 1, wherein the information indicating the channel occupation status is reported to the base station through a physical uplink control channel (PUCCH) or a physical uplink shared channel (PUSCH).

5. The method according to claim 1, further comprising receiving a message requesting to measure the channel occupation status from the base station.

6. The method according to claim 5, wherein the message includes information on periodicity of the measurement period and a start time of the measurement of the received signal strength.

7. The method according to claim 6, wherein the message further includes information on a channel frequency to be measured, the predetermined threshold, and a length of the measurement period.

8. The method according to claim 5, wherein the message is a radio resource control (RRC) message.

9. An operation method of a base station in a communication network, the method comprising:
generating a first message requesting measurement of a channel occupation status;
transmitting the first message to a user equipment (UE); and
in response to the first message, receiving, from the UE, a second message including information indicating the channel occupation status determined based on a result of comparison between a predetermined threshold and received signal strength measured during a measurement period in an unlicensed band.

10. The method according to claim 9, wherein the channel occupation status is determined as a ratio of a period of time during which the received signal strength is not less than the predetermined threshold to the measurement period.

11. The method according to claim 9, wherein the channel occupation status is determined as a ratio of a number of samples of the received signal strength which is not less than the predetermined threshold to a number of total samples of the received signal strength in the measurement period.

12. The method according to claim 9, wherein the first message includes information on periodicity of the measurement period and a start time of the measurement of the received signal strength.

13. The method according to claim 12, wherein the first message further includes information on a channel frequency to be measured, the predetermined threshold, and a length of the measurement period.

14. The method according to claim 9, wherein the first message is a radio resource control (RRC) message.

15. The method according to claim 9, wherein the second message is received from the UE through a physical uplink control channel (PUCCH) or a physical uplink shared channel (PUSCH).

16. A user equipment (UE) supporting an unlicensed band, including a processor and a memory in which at least one instruction executed by the processor is stored,
wherein the at least one instruction:
measures received signal strength during a measurement period in an unlicensed band;
determines a channel occupation status by comparing the measured received signal strength with a predetermined threshold; and
reports information indicating the channel occupation status to a base station.

17. The UE according to claim 16, wherein the channel occupation status is determined as a ratio of a period of time during which the received signal strength is not less than the predetermined threshold to the measurement period.

18. The UE according to claim 16, wherein the channel occupation status is determined as a ratio of a number of samples of the received signal strength which is not less than the predetermined threshold to a number of total samples of the received signal strength in the measurement period.

19. The UE according to claim 16, wherein the at least one instruction further receives a message requesting measurement of the channel occupation status from the base station.

20. The UE according to claim 19, wherein the message further includes information on a channel frequency to be measured, the predetermined threshold, and a length of the measurement period.
